(19) United States
(12) Patent Application Publication
(10) Pub. No.: US 2017/0179446 A1
(43) Pub. Date: Jun. 22, 2017

(54) PACKAGE FOR ELECTROCHEMICAL CELL, AND ELECTROCHEMICAL CELL

(71) Applicant: KYOCERA Corporation, Kyoto-shi, Kyoto (JP)

(72) Inventor: Kiyotaka YOKOI, Kyoto-shi (JP)

(73) Assignee: KYOCERA Corporation, Kyoto-shi, Kyoto (JP)

(21) Appl. No.: 15/116,888

(22) PCT Filed: Feb. 17, 2015
(86) PCT No.: PCT/JP2015/054238

§ 371 Date: Aug. 5, 2016

(30) Foreign Application Priority Data
Feb. 17, 2014 (JP) 2014-027332

(51) Int. Cl. H01M 2/02; H01M 2/06; H01G 11/60; H01G 11/14; H01G 11/22; H01G 11/80

(52) U.S. Cl. CPC H01M 2/0292; H01G 11/22; H01G 11/80; H01G 11/60; H01G 11/14; H01M 2/065

(57) ABSTRACT

A package for an electrochemical cell includes a rectangular substrate including a via conductor; and a rectangular frame disposed on an upper face of the substrate and enclosing the via conductor. The package includes a wiring conductor extending from the via conductor toward a center region excluding a peripheral region in the upper face enclosed by the frame; and a ceramic coat layer extending from the wiring conductor toward the peripheral region and being provided with a through hole in the center region and a slit in the peripheral region; and a rectangular corrosion protection electrode layer extending from the ceramic coat layer toward an inside of the through hole in the center region and connected to the wiring conductor. The slit is provided in each of four corners crossing an extension line of a diagonal line of the corrosion protection electrode layer within the peripheral region.

### TECHNICAL FIELD

The present invention relates to a package for an electrochemical cell, and to an electrochemical cell.

### BACKGROUND ART

Electrochemical cells capable of being mounted on a surface are used as a backup power supply for a clock function of a smartphone, a backup power supply for a semiconductor memory, and the like. In an electrochemical cell having been developed as the above-mentioned one, a ceramic package is employed.

In such an electrochemical cell, an active material serving as a positive electrode or a negative electrode and an electrolyte composed of a non-aqueous solvent are provided in the inside. In the inside of a package for an electrochemical cell, a wiring conductor is arranged around. Thus, a technique is disclosed that in order that the wiring conductor may be not dissolved into the active material or the electrolyte, a part of the wiring conductor is covered by a ceramic coat layer and the remaining part is covered by an electrically conductive material having anti-corrosiveness (for example, see Japanese Unexamined Patent Publication 2007-5278).

In such a package for an electrochemical cell, a difference in the thermal expansion between the ceramic coat layer and the wiring conductor or the electrically conductive material having anti-corrosiveness causes a possibility that a crack occurs in the ceramic coat layer or the electrically conductive material having anti-corrosiveness separates from the ceramic coat layer so that the wiring conductor is dissolved into the electrolyte and hence the product lifetime becomes short.

The invention has been devised in view of the above-mentioned problem. An object thereof is to provide a package for an electrochemical cell and an electrochemical cell whose product lifetime can be maintained satisfactory.

### SUMMARY OF INVENTION

A package for an electrochemical cell according to an embodiment of the invention includes: a rectangular substrate including an upper face and a lower face, the rectangular substrate including a via conductor extending from the upper face toward the lower face; and a rectangular frame disposed on the upper face, the rectangular frame enclosing the via conductor in a plan view. Further, the package for an electrochemical cell includes: a wiring conductor extending from the via conductor toward a center region excluding a peripheral region in the upper face enclosed by the rectangular frame; and a ceramic coat layer extending from the wiring conductor toward the peripheral region, the ceramic coat layer being provided with a through hole formed in the center region and a slit formed in the peripheral region. Further the package for an electrochemical cell includes a rectangular corrosion protection electrode layer extending from the ceramic coat layer toward an inside of the through hole in the center region, the rectangular corrosion protection electrode layer being electrically connected to the wiring conductor. The slit is provided in each of four corners crossing an extension line of a diagonal line of the corrosion protection electrode layer within the peripheral region.

An electrochemical cell according to an embodiment of the invention includes: the package for an electrochemical cell described above; an active material serving as a positive electrode or a negative electrode; and an electrolyte composed of a non-aqueous solvent, the active material and the electrolyte being contained in the package for an electrochemical cell.

### BRIEF DESCRIPTION OF DRAWINGS

FIG. 1 is a perspective view showing the external appearance of an electrochemical cell according to the present embodiment;

FIG. 2 is a perspective top view showing the external appearance of a package for an electrochemical cell according to the present embodiment;

FIG. 3 is a perspective bottom view showing the external appearance of the package for an electrochemical cell according to the present embodiment;

FIG. 4 is a plan view showing the inside of the package for an electrochemical cell according to the present embodiment;

FIG. 5 is a sectional view of an electrochemical cell taken along line X-X in FIG. 1;

FIG. 6 is a sectional view of the package for an electrochemical cell taken along line Y-Y in FIG. 2; and

FIG. 7 is an example of a plan view showing the inside of the package for an electrochemical cell according to the present embodiment.

### DESCRIPTION OF EMBODIMENTS

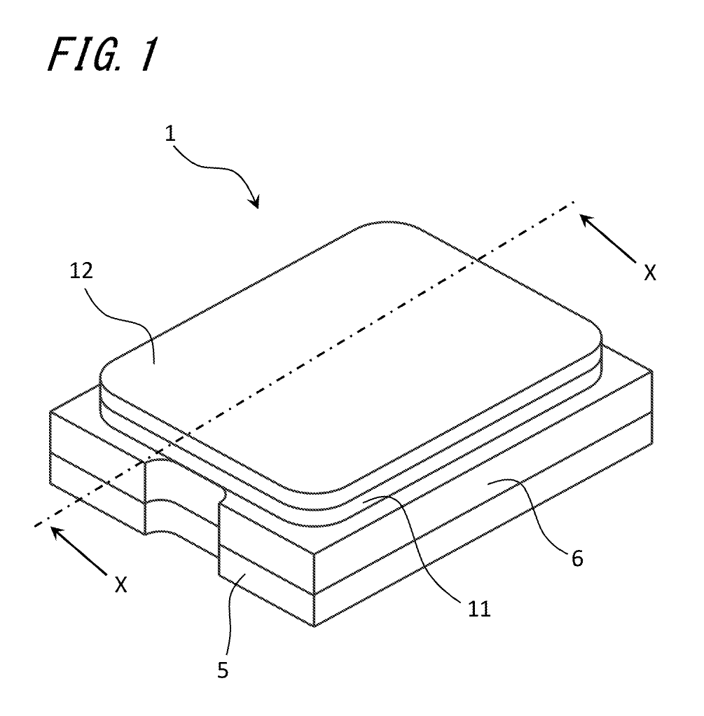

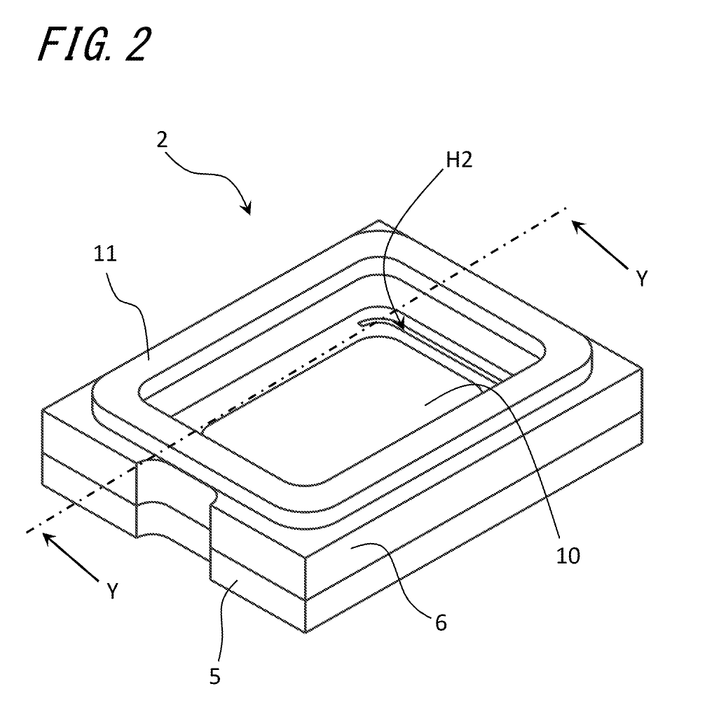

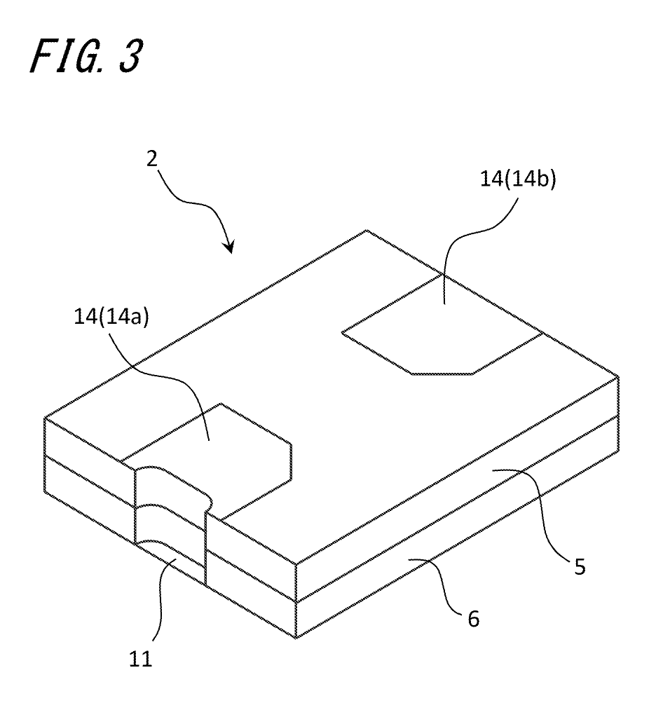

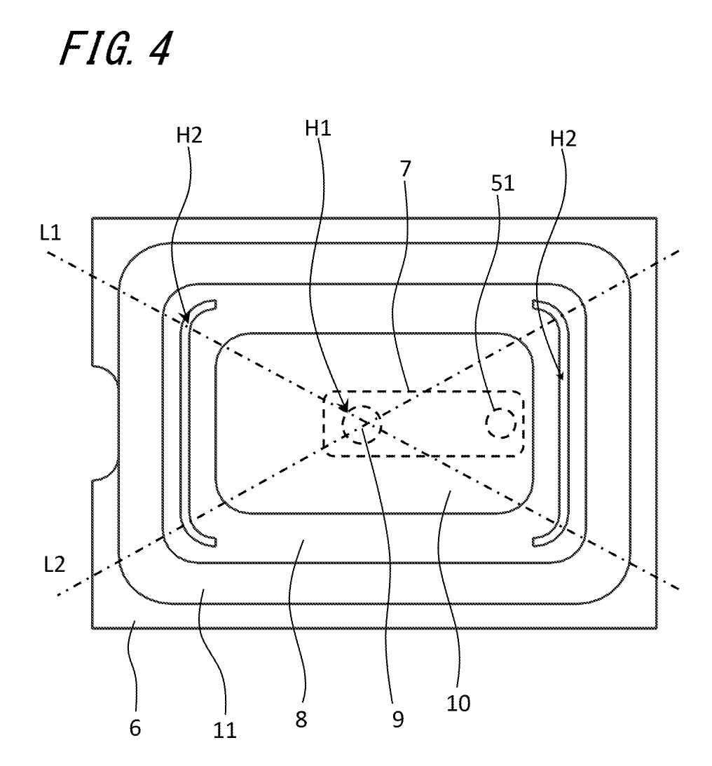

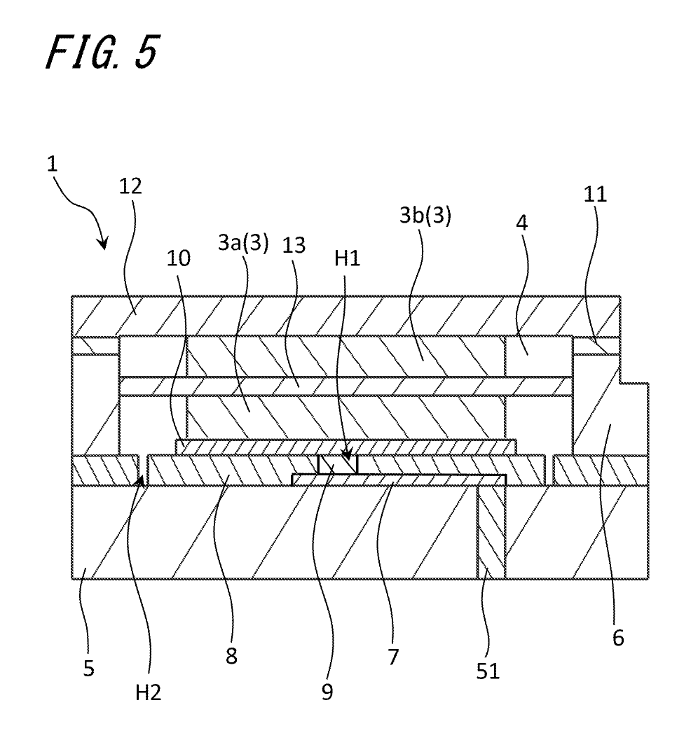

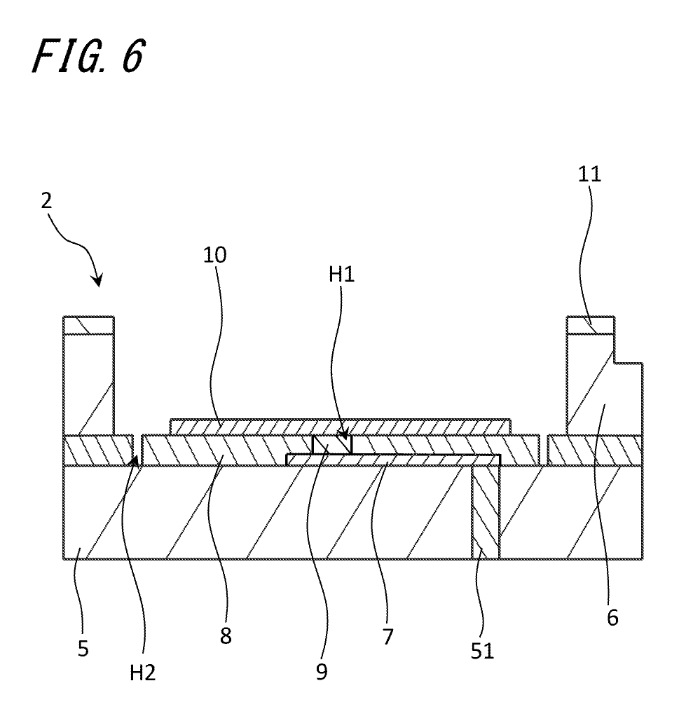

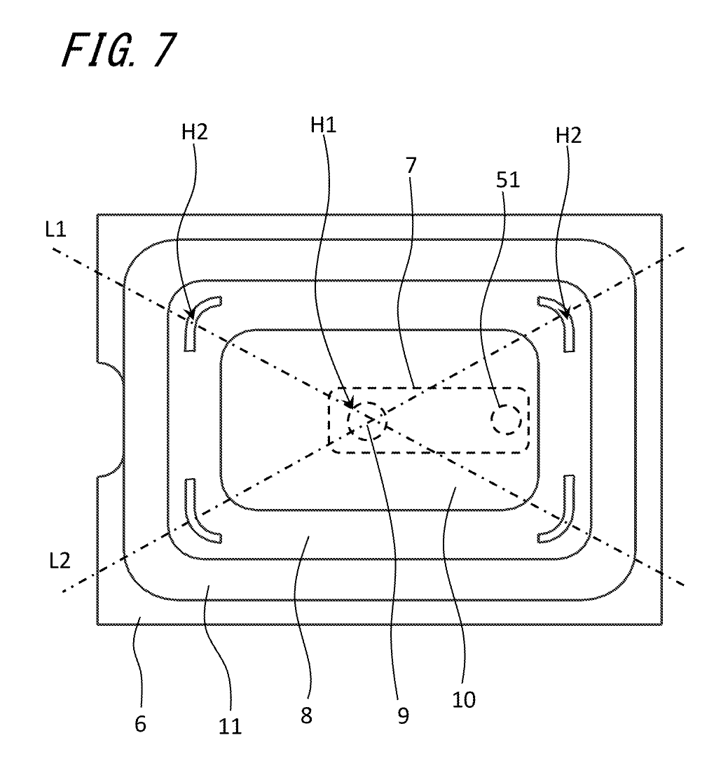

An embodiment of a package for an electrochemical cell and an electrochemical cell according to the invention is described below with reference to the accompanying drawings. FIG. 1 is an external appearance perspective view of an electrochemical cell according to the present embodiment. FIG. 2 is an external appearance perspective view of a package for an electrochemical cell according to the present embodiment. FIG. 3 is an external appearance perspective view showing the bottom face of the package for an electrochemical cell according to the present embodiment. FIG. 4 is a plan view showing the upper face of the package for an electrochemical cell according to the present embodiment, where dashed lines indicate a via conductor, a wiring conductor, and a plating layer provided in a portion covered by an electrically conductive layer or a ceramic coat layer. FIG. 5 is a sectional view of an electrochemical cell taken along line X-X in FIG. 1. FIG. 6 is a sectional view of the package for an electrochemical cell taken along line Y-Y in FIG. 2. FIG. 7 is an example of a plan view showing the inside of the package for an electrochemical cell according to the present embodiment.

<Configuration of Electrochemical Cell>

An electrochemical cell of the present embodiment is employed in a non-aqueous electrolyte battery, an electric double layer capacitor, or the like and has an electricity generation function or an electricity storage function. The electrochemical cell can be used as: a backup power supply for a watch or a semiconductor memory; a standby power supply for an electronic apparatus such as a microcomputer and an IC memory; a power supply for a control circuit of a solar watch or for electric motor driving; or the like. Further, the electrochemical cell can be used as: a power supply for an electric vehicle; an auxiliary electricity storage unit of an energy conversion and storage system; or the like.

The electrochemical cell 1 according to the present embodiment includes: a package 2 for an electrochemical cell; and an active material 3 serving as a positive electrode or a negative electrode and an electrolyte 4 composed of a non-aqueous solvent which are provided in the inside of the package 2 for an electrochemical cell.

The package 2 for an electrochemical cell includes: a rectangular substrate 5 including a via conductor 51; and a rectangular frame 6 disposed on the upper face of the substrate and enclosing the via conductor 51. Further, the package includes: a wiring conductor 7 extending from the via conductor 51 toward a center region excluding a peripheral region in the upper face enclosed by the frame 6; a ceramic coat layer 8 extending from the wiring conductor 7 toward the peripheral region, the ceramic coat layer 8 being provided with a through hole H1 formed in the center region and a slit H2 formed in the peripheral region; and a rectangular corrosion protection electrode layer 10 extending from the ceramic coat layer 8 toward the inside of the through hole H1 in the center region, the rectangular corrosion protection electrode layer 10 being electrically connected to the wiring conductor 7. The slit H2 is provided in each of the four corners crossing an extension line L1 or L2 of each diagonal line of the corrosion protection electrode layer 10 within the peripheral region.

The substrate 5 has an upper face and a lower face and includes the via conductor 51 extending the upper face toward the lower face. The substrate 5 has a rectangular outer shape and is formed of an insulating stack of a plurality of insulating layers. For example, the substrate 5 is formed of a ceramic material such as alumina, mullite, and aluminum nitride, a glass ceramic material, or the like. Alternatively, a composite material obtained by mixing a plurality of these materials may be employed. Further, for example, the thickness of the substrate 5 is set to be 0.2 mm or greater and 2 mm or smaller.

The via conductor 51 is provided in the substrate 5. As shown in FIG. 5 or 6, the via conductor 51 is provided so as to pass through the substrate 5. However, employable configurations are not limited to this. As long as electrical connection to the wiring conductor 7 is established, the via conductor 51 may extend from the upper face of the substrate 5 to the middle not reaching the lower face. Specifically, the via conductor 51 may extend from the upper face of the substrate 5 toward the inside of the substrate 5, then an internal electrically-conductive layer may extend from the lower end of the via conductor 51 toward the side face of the substrate 5, and then electrical connection may be formed from the internal electrically-conductive layer to a side face electrically-conductive layer disposed on the side face of the substrate 5. Further, the via conductor 51 may extend from the upper face of the substrate 5 overlapping with the through hole H1 in the package 2 for an electrochemical cell toward the inside of the substrate 5, then the wiring conductor 7 may be disposed on the upper end of the via conductor 51, then an internal electrically-conductive layer may extend from the lower end of the via conductor 51 toward the side face of the substrate 5, and then the via conductor 51 may be provided so that electrical connection is established from the internal electrically-conductive layer to the side face electrically-conductive layer disposed on the side face of the substrate 5 so that electrical connection to a lower face electrode 14 may be established. By virtue of this, the length and the area of the wiring conductor 7 can be reduced and hence a stress caused by a difference in the thermal expansion between the substrate 5, the wiring conductor 7, and the ceramic coat layer 8 can be reduced. This suppresses a situation that the wiring conductor 7 separates from the substrate 5, the ceramic coat layer 8, or the via conductor 51 or, alternatively, the wiring conductor 7 becomes electrically broken.

The via conductor 51 is formed of an electrically conductive material. That is, for example, the via conductor 51 is formed of a metallic material such as tungsten, molybdenum, manganese, nickel, copper, silver, and gold, or an alloy of these materials, or a composite material obtained by mixing a plurality of these materials, or a composite layer of these materials. For example, the diameter of the via conductor 51 is set to be 0.1 mm or greater and 1 mm or smaller.

The frame 6 is disposed on the substrate 5. The frame 6 is disposed so as to enclose the via conductor 51 in a plan view. The frame 6 is configured by stacking together a plurality of insulating frame boards. For example, the frame 6 is formed of a ceramic material such as alumina, mullite, and aluminum nitride, a glass ceramic material, or the like. Alternatively, a composite material obtained by mixing a plurality of these materials may be employed. Further, for example, the thickness of the frame 6 is set to be 0.2 mm or greater and 2 mm or smaller.

The wiring conductor 7 is disposed on the upper face of the substrate 5. The wiring conductor 7 is connected to the upper end of the via conductor 51. The wiring conductor 7 extends from the via conductor 51 toward the upper face of the substrate 5. Then, a part of the upper face of the substrate 5 is exposed. The wiring conductor 7 is formed of an electrically conductive material similar to the via conductor 51. That is, for example, the wiring conductor 7 is formed of a metallic material such as tungsten, molybdenum, manganese, nickel, copper, silver, and gold, or an alloy of these materials, or a composite material obtained by mixing a plurality of these materials, or a composite layer of these materials. Here, for example, the thickness of the wiring conductor 7 is set to be 2 μm or greater and 20 μm or smaller. For example, the thermal expansion coefficient of the wiring conductor 7 is set to be 4.5×10-6/K or higher and 53×10-6/K or lower.

The ceramic coat layer 8 is provided within a region enclosed by the frame 6 and extends from the wiring conductor 7 toward the exposed portion of the upper face of the substrate 5. The ceramic coat layer 8 covers a large part of the wiring conductor 7 so as to suppress corrosion of the wiring conductor caused by the electrolytic solution of the electrolyte. As shown in FIG. 4, the ceramic coat layer 8 is provided with: the through hole H1 formed in a portion overlapping with the wiring conductor 7 in a plan view; and the slit H2 formed in a portion overlapping with the exposed portion of the substrate 5. Here, the ceramic coat layer 8 may extend toward the upper face of the substrate 5 overlapping with the frame 6 in the package 2 for an electrochemical cell. By virtue of this, it is possible to suppress a situation that the electrolyte 4 filling the package 2 for an electrochemical cell permeates the joining part between the substrate 5 and the frame 6. This suppresses a situation that a metal layer, a penetration conductor, or the like disposed on the upper face or in the inside of the substrate 5 is corroded by the electrolyte 4.

A ceramic paste employed for the ceramic coat layer 8 is obtained by adding a suitable amount of sintering aids such as manganese oxide, copper oxide, and silicon oxide to alumina powder, then adding additives such as a binder composed of acrylic resin or the like together with an organic solvent such as toluene to the powder, and then kneading these materials by using a ball mill. Here, for example, the thickness of the ceramic coat layer 8 is set to be 3 μm or greater and 15 μm or smaller. For example, the thermal expansion coefficient of the ceramic coat layer 8 is set to be 7×10-6/K or higher and 8×10-6/K or lower.

The ceramic coat layer 8 extends from the wiring conductor 7 toward the peripheral region and is provided with the through hole H1 formed in the center region and the slit H2 formed in the peripheral region. The through hole H1 is provided in a portion overlapping with the wiring conductor 7. The through hole H1 is used for providing a plating layer 9. As for the size, for example, the diameter is set to be 0.1 mm or greater and 1 mm or smaller. For example, the depth of the through hole H1 is set to be 3 μm or greater and 15 μm or smaller. Further, the slit H2 provided in overlap with the exposed portion of the upper face of the substrate 5. The slit H2 is used to distribute a thermal stress at the time of sintering of the ceramic coat layer 8, a thermal stress at the time of environmental test of the package 2 for an electrochemical cell, or a thermal stress at the time of operation of the electrochemical cell 1, or to measuring the thickness of the ceramic coat layer 8. Here, the slit H2 is provided within a region enclosed by the frame 6 along the edge of the frame 6. For example, the depth of the slit H2 is set to be 3 μm or greater and 15 μm or smaller.

As shown in FIGS. 4 and 7, the corrosion protection electrode layer 10 is formed in a rectangular shape and then the slit H2 is formed in each of at least the four corners such as to cross an extension line L1 or L2 of each diagonal line of the corrosion protection electrode layer 10. A difference in the thermal expansion between the corrosion protection electrode layer 10 and the ceramic coat layer 8 causes a possibility that a crack occurs in the ceramic coat layer 8 or alternatively the corrosion protection electrode layer 10 separates from the ceramic coat layer 8. However, a thermal stress generated in the corners of the corrosion protection electrode layer 10 by thermal expansion or thermal contraction in the diagonal directions of the corrosion protection electrode layer 10 can be alleviated or isolated by the slits H2. Here, the thermal expansion or thermal contraction in the corrosion protection electrode layer 10 becomes largest on the extension line L1 or L2 of each diagonal line of the corrosion protection electrode layer 10. Thus, when the slit H2 provided in that portion, the thermal stress generated in the corrosion protection electrode layer 10 or the ceramic coat layer 8 can effectively be alleviated or isolated. As shown in FIG. 7, in a case where the long side of the corrosion protection electrode layer 10 is 1.8 mm, where the short side of the corrosion protection electrode layer 10 is 0.5 mm, and where the thickness of the corrosion protection electrode layer 10 is 0.015 mm, for example, the slit H2 in one of the four corners of the corrosion protection electrode layer 10 is formed so that the width of the slit H2 is 0.05 mm and the length of the slit H2 is 0.15 mm.

The difference of the depths of the through hole H1 and the slit H2 is set to be 5 μm or smaller. In a case where the depth of the slit H2 can be set equal to the depth of the through hole H1, the depth of the through hole H1 can be estimated when the depth of the slit H2 is measured. The through hole H1 need be formed on the wiring conductor 7. Further, in order to reduce the thermal stress of the plating layer 9, it is impossible to increase the area of the through hole H1. Furthermore, in a case where the area of the through hole H1 in a plan view is increased, a part of the upper face of the wiring conductor 7 exposed through the through hole H1 is exposed to the outside until the plating layer 9 is formed. This causes a strong possibility that the wiring conductor 7 in this portion and the vicinity is oxidized. In the package 2 for an electrochemical cell according to the present embodiment, the area of the through hole H1 in a plan view is set to be small so that the thermal stress generated in the plating layer 9 can be reduced and, further, oxidation of the wiring conductor 7 can be suppressed. Nevertheless, with decreasing area of the through hole H1, it becomes more difficult to find the through hole H1 and then measure the depth of the through hole H1. Thus, the slit H2 is provided separately from the through hole H1. By virtue of this, the depth of the through hole H1 can be estimated when the depth of the slit H2 is measured.

As shown in FIG. 4, the slit H2 may be provided on each of both sides of the corrosion protection electrode layer 10 with the corrosion protection electrode layer 10 interposed therebetween. Further, as for the slit H2, when a laser beam is scanned in a direction crossing the slit H2, the laser beam necessarily hits against the slit H2 and hence the depth of the slit H2 can be measured on the basis of the data. As a result, the depth of the through hole H1 can be estimated.

Further, as shown in FIG. 4, the respective slits H2 may extend along a direction orthogonal to the longitudinal direction of the corrosion protection electrode layer 10 in a plan view to connect to each other. When the respective slits H2 extend along the direction orthogonal to the longitudinal direction of the corrosion protection electrode layer 10 to connect to each other, an operation effect is achieved that in the longitudinal direction of the corrosion protection electrode layer 10 where the thermal expansion or thermal contraction in the corrosion protection electrode layer 10 becomes large, the thermal stress generated in the ceramic coat layer 8 located between the corrosion protection electrode layer 10 and the frame 6 can be reduced.

Further, the portion of the slit H2 formed in each of the four corners in the peripheral region may be bent along the corner of the corrosion protection electrode layer 10. Alternatively, the slit H2 may be in a straight shape. When the slit H2 is bent along the corner of the corrosion protection electrode layer 10, an operation effect is achieved that the thermal stress generated in the ceramic coat layer 8 located between the corner of the corrosion protection electrode layer 10 and the frame 6 is distributed along the bent shape of the slit H2 without being concentrated in a particular part. Here, as shown in FIG. 4, the slit H2 may be provided in a manner of being bent in a curved shape convex toward the frame 6 along the corner of the corrosion protection electrode layer 10. By virtue of this, an operation effect is achieved that the thermal stress generated in the ceramic coat layer 8 located between the corner of the corrosion protection electrode layer 10 and the frame 6 can be distributed by the slit H2.

Further, in the ceramic coat layer 8, when the respective slits H2 extend along a direction orthogonal to the longitudinal direction of the corrosion protection electrode layer 10 to connect to each other, the stress of expanding or contracting the ceramic coat layer 8 caused by the difference in the thermal expansion between the corrosion protection electrode layer 10 and the ceramic coat layer 8 or by the thermal expansion or thermal contraction in the corrosion protection electrode layer 10 occurring at the time of fabrication or an environmental test of the package 2 for an electrochemical cell or alternatively at the time of operation of the electrochemical cell 1 can be distributed by the intervention of the slit H2. As a result, it is possible to suppress a situation that the stress is concentrated in the ceramic coat layer 8 provided between the corrosion protection electrode layer 10 and the frame 6 in the longitudinal direction of the corrosion protection electrode layer 10 so that the ceramic coat layer 8 is broken or alternatively the corrosion protection electrode layer 10 separates from the ceramic coat layer 8. When the ceramic coat layer 8 is broken or alternatively the corrosion protection electrode layer 10 separates from the ceramic coat layer 8, the electrolyte permeates the wiring conductor 7. However, when the ceramic coat layer 8 is less prone to be broken and the corrosion protection electrode layer 10 is less prone to separate from the ceramic coat layer 8, it is possible to provide the package 2 for an electrochemical cell and the electrochemical cell 1 in which degradation of the wiring conductor 7 is suppressed so that improvement in the product lifetime can be achieved.

The plating layer 9 is provided in the inside of the through hole H1. For example, the plating layer 9 has a two-layer structure in which the lower layer is composed of a material excellent in connectivity with the wiring conductor 7 and excellent in corrosiveness and the upper layer is composed of a material having a low resistance and excellent in connectivity with the lower layer.

The corrosion protection electrode layer 10 extends toward the ceramic coat layer 8. The corrosion protection electrode layer 10 is formed simultaneously with the plating layer 9 and hence composed of the same material. Further, for the purpose of suppressing the thermal stress generated between the corrosion protection electrode layer 10 and the ceramic coat layer 8 in the longitudinal direction of the corrosion protection electrode layer 10, the corrosion protection electrode layer 10 is not provided in a portion overlapping with the slit H2. The corrosion protection electrode layer 10 serves as one electrode of a battery and has a potential difference in which the difference value during charging and the difference value during discharging are reversed to each other with respect to the other electrode. Here, for example, the corrosion protection electrode layer 10 is composed of a metallic material such as gold, silver, titanium, and aluminum having excellent corrosion resistance and a small electric resistance or, alternatively, a composite layer of those materials. Here, a part of the corrosion protection electrode layer 10 formed in the inside of the through hole H1 serve as the plating layer 9.

A seal ring 11 is brazed onto the frame 6 with intervention of a metal layer and a jointing material such as a brazing material. Here, for example, the brazing material is composed of silver, copper, gold, aluminum, magnesium, or the like and may contain additives such as nickel, cadmium, and phosphorus. The seal ring 11 is a frame-shaped member overlapping with the frame 6 disposed on the substrate 5 in a plan view. For example, the seal ring 11 is formed of a shock absorbing material having an excellent thermal conductivity such as copper, iron, tungsten, molybdenum, nickel, and cobalt. Here, the seal ring 11 is connected to the frame 6 by using a solid jointing material. The jointing material is placed on the metal layer disposed on the upper face of the frame 6, then the seal ring 11 is stacked on the jointing material, and then heat is applied to the seal ring 11 so that the jointing material is melted and hence the metal layer is connected to the seal ring 11. Further, when the jointing material having been melted is cooled and solidified, the seal ring 11 is fixed to the frame 6 via the metal layer and the jointing material so that electrical conduction is established.

Further, a lid 12 is disposed on the seal ring 11. The lid 12 is disposed on the seal ring 11 in a state where a positive electrode 3a, a separator 13, and a negative electrode 3b are stacked together in a region enclosed by the frame 6 on the upper face of the substrate 5 and then the space is filled with the electrolyte 4. The lid 12 has a function of sealing the space enclosed by the substrate 5 and the frame 6. For example, the lid 12 is brazed on the frame 6 via a brazing material. Alternatively, the lid 12 is welded onto the seal ring 11 by resistance seam welding, laser seam welding, electron beam welding, or the like. Here, for example, the lid 12 is formed of a metallic material such as copper, iron, tungsten, molybdenum, nickel, and cobalt or an alloy containing these metallic materials.

In a region enclosed by the frame 6 on the substrate 5, the positive electrode 3a, the separator 13, and the negative electrode 3b are stacked in this order from the wiring conductor 7 side and then the space is filled with the electrolyte 4. When the positive electrode 3a, the separator 13, the negative electrode 3b, and the electrolyte 4 in this order are contained in the region enclosed by the frame 6 on the substrate 5 and then the lid 12 is connected via the seal ring 11, the positive electrode 3a, the separator 13, the negative electrode 3b, and the electrolyte 4 can be sealed in the inside of the package 2 for an electrochemical cell. Here, the positive electrode 3a or the negative electrode 3b serves as the active material 3.

The positive electrode 3a is electrically connected to the corrosion protection electrode layer 10. Then, the corrosion protection electrode layer 10 is electrically connected through the plating layer 9, the wiring conductor 7, and the via conductor 51 to the lower face electrode 14a formed on the lower face of substrate 2 and serving as the positive electrode. Further, the negative electrode 3b is electrically connected to the lid 12 or the metal layer formed on the upper face of the frame 6. Then, the lid 12 or the metal layer extends via the side face of the frame 6 and the side face of substrate 2 to the lower face of substrate 2, and is then electrically connected to the lower face electrode 14b which is formed on the lower face of substrate 2 and serves as the negative electrode.

When the electrochemical cell 1 is to be used as a non-aqueous electrolyte battery serving as an electricity generation element, for example, the positive electrode 3a may be formed of a metal chalcogen compound such as titanium disulfide, a metal oxide such as manganese oxide and molybdenum oxide, an electroconductive polymer such as polyaniline, polypyrrole, and poly para-phenylene, or various substances capable of absorbing and releasing lithium ions and anions. Further, for example, the negative electrode 3b may be formed of various substances such as silicon oxide, tungstic trioxide, and tin oxide.

When the electrochemical cell 1 is to be used as an electric double layer capacitor, the active material for the positive electrode 3a and the negative electrode 3b may be composed of activated carbon or activated carbon fiber. Further, the separator 13 may be formed of nonwoven fabric whose dissolubility to or chemical reactivity with the non-aqueous electrolyte are low and whose heat resistance is satisfactory.

The separator 13 is an insulator film having a high ion permeability and a satisfactory mechanical strength. For example, the separator 13 may be formed of a resin such as polyolefin, polyphenylene sulfide, and polyether ether ketone, or a glass fiber, or a ceramic porous material.

For example, the electrolyte 4 of non-aqueous solvent may be formed of a material obtained by dissolving phosphoric acid lithium hexafluoride, lithium borofluoride, lithium trifluoromethanesulfonate, or lithium perfluoro ethyl sulfonylimide in an organic solvent composed of propylene carbonate, butylene carbonate, sulfolane, ethylene carbonate, acetonitrile, dimethoxyethane, methyl formate, or the like alone or a suitable mixture of these.

In the electrochemical cell 1 according to the present embodiment, the ceramic coat layer 8 is provided with the through hole H1 formed in a portion overlapping with the wiring conductor 7 in a plan view and with the slit H2 formed in a portion overlapping with the exposed portion. By virtue of this, the depth of the through hole H1 can be estimated on the basis of the depth of the slit H2 and the thickness of the plating layer 9 can arbitrarily be controlled. At the same time, the corrosion protection electrode layer 10 can be formed continuously on the ceramic coat layer 8 and on the plating layer 9. As a result, it is possible to suppress a situation that the internal solution or the like permeates the wiring conductor 7 from the boundary between the plating layer 9 and the ceramic coat layer 8. Further, it is possible to suppress a situation that the material of the wiring conductor 7 is dissolved into the active material 3 and the electrolyte 4. Thus, degradation of the active material 3 and the electrolyte 4 can be suppressed so that improvement in the product lifetime can be achieved.

Here, the invention is not limited to the above-mentioned embodiment, and various changes, improvements, and the like are possible without departing from the scope of the invention.

<Method of Manufacturing Electrochemical Cell>

Here, a method of manufacturing the electrochemical cell 1 shown in FIG. 1 is described below. First, the substrate 5 and the frame 6 are prepared. The substrate 5 and the frame 6 are formed of a sintered body of a stack of a plurality of green sheets. For example, the green sheet constituting the substrate 5 and the frame 6 is obtained by adding and mixing an organic binder, a plasticizer, a solvent, and the like into raw material powder of aluminum oxide, silicon oxide, magnesium oxide, calcium oxide, or the like and then molding the obtained mixture.

Next, a metal paste is prepared. The metal paste is obtained by preparing high melting-point metal powder of tungsten, molybdenum, or the like and then adding and mixing an organic binder, a plasticizer, a solvent, and the like into the powder.

Then, the metal paste is applied by screen printing onto a plurality of the green sheets constituting the substrate 5 or the frame 6, so that the via conductor 51, the wiring conductor 7, and the metal layer disposed on the upper face of the frame 6 are formed. Further, the ceramic coat layer 8 is formed in advance on the substrate 5 and the wiring conductor 7 by screen printing in a manner that the through hole H1 and the slit H2 are provided.

Next, the prepared not-yet-sintered green sheets constituting the substrate 5 or the frame 6 in a state of being stacked together are fired at a temperature of approximately 1600° C. After that, the seal ring 11 processed into a predetermined shape is joined to the metal layer disposed on the upper face of the frame 6 via a brazing material. Then, the plating layer 9 is formed in the through hole H1, then the corrosion protection electrode layer 10 is disposed on the ceramic coat layer 8, and then necessary plating, brazing, and the like are performed so that the package 2 for an electrochemical cell is manufactured. Then, the positive electrode 3a, the separator 13, and the negative electrode 3b in this order are provided in the inside of the frame 6 and then the space is filled with the electrolyte 4.

Next, the lid 12 is prepared and then the lid 12 is fixed to the frame 6 via the seal ring 11 so as to close an opening of the frame 6 so that the electrochemical cell 1 is manufactured.

1. A package for an electrochemical cell, comprising:
a rectangular substrate including an upper face and a lower face, the rectangular substrate comprising a via conductor extending from the upper face toward the lower face;
a rectangular frame disposed on the upper face, the rectangular frame enclosing the via conductor in a plan view;
a wiring conductor extending from the via conductor toward a center region excluding a peripheral region in the upper face enclosed by the rectangular frame;
a ceramic coat layer extending from the wiring conductor toward the peripheral region, the ceramic coat layer being provided with a through hole formed in the center region and a slit formed in the peripheral region; and
a rectangular corrosion protection electrode layer extending from the ceramic coat layer toward an inside of the through hole in the center region, the rectangular corrosion protection electrode layer being electrically connected to the wiring conductor,
the slit being provided in each of four corners crossing an extension line of a diagonal line of the corrosion protection electrode layer within the peripheral region.

2. The package for an electrochemical cell according to claim 1, wherein
the respective slits extend along a direction orthogonal to a longitudinal direction of the corrosion protection electrode layer to connect to each other.

3. The package for an electrochemical cell according to claim 2, wherein
a portion of the slit formed in each of the four corners is bent along the corner of the corrosion protection electrode layer.

4. The package for an electrochemical cell according to claim 1, wherein
the corrosion protection electrode layer is formed of vapor deposition plated aluminum.

5. An electrochemical cell, comprising:
the package for an electrochemical cell according to claim 1;
an active material serving as a positive electrode or a negative electrode; and
an electrolyte composed of a non-aqueous solvent, the active material and the electrolyte being contained in the package for an electrochemical cell.
